(19) United States
(12) Patent Application Publication
(10) Pub. No.: US 2026/0061918 A1
(43) Pub. Date: Mar. 5, 2026

(54) COCKPIT TABLE ASSEMBLY

(71) Applicant: HYUNDAI MOBIS CO., LTD., Seoul (KR)

(72) Inventor: Ik Keun CHOI, Yongin-si (KR)

(73) Assignee: HYUNDAI MOBIS CO., LTD., Seoul (KR)

(21) Appl. No.: 19/087,915

(22) Filed: Mar. 24, 2025

(30) Foreign Application Priority Data
Sep. 5, 2024 (KR) 10-2024-0120848

(51) Int. Cl. B60N 3/00

(52) U.S. Cl. CPC B60N 3/002

(57) ABSTRACT

A cockpit table assembly according to one embodiment of the present invention may include a glove box door which is configured to open or close a glove box, a table groove formed in one side of the glove box, and a table which is slidably disposed in the table groove and in which a plurality of fixing holes are formed, wherein at least portions of an edge of the glove box door may protrude to form fixing pins, the table is movable forward or rearward inside the table groove when the glove box door opens the glove box, and the fixing pins may be inserted into the fixing holes to fix a position of the table when the glove box door closes the glove box.

### CROSS-REFERENCE TO RELATED APPLICATION

This application claims priority to and the benefit of Korean Patent Application No. 10-2024-0120848, filed on Sep. 5, 2024, the disclosure of which is incorporated herein by reference in its entirety.

### BACKGROUND

### Field of the Invention

The present invention relates to a cockpit table assembly, and more specifically, to a cockpit table assembly which is easy to fix and store when a vehicle travels.

### Discussion of Related Art

As functions provided by vehicles are diversified, the utilization of the vehicles is increasing. The time that a user stays in a vehicle can be increased, and various activities can be performed in the vehicle. When a user sits in a vehicle for a long time, there may be a case in which the user eats food in the vehicle or watches images through a separate device. A table, on which food or devices such as a handphone can be placed, may be provided in the vehicle.

Since the vehicle has a limited space, the table provided in the vehicle may be stored inside another component when the table is not used. A cockpit module provided in a front portion of the vehicle occupies a large volume, and an air conditioning apparatus, an airbag, and other components are embedded in the cockpit module. A space into which the table can be inserted may be provided inside the cockpit module, and the corresponding space may be disposed adjacent to a glove box to improve utilization of a space.

When a vehicle travels, inertia can make a problem that a table may escape from the stored space or may not be fixed while being used. Since the table needs to be stably fixed at a predetermined location in the cockpit module, there is a demand for a vehicle table that can be easily stored and fixed with a specific arrangement.

### SUMMARY OF THE INVENTION

The present invention is directed to providing a cockpit table assembly that is easy to store and fix a table.

Objectives to be solved by the present invention are not limited to the above-described objectives, and other objectives which are not described above may be clearly understood by those skilled in the art through the following description.

According to an aspect of the present invention, there is provided a cockpit table assembly including a glove box door which is configured to open or close a glove box, a table groove formed in one side of the glove box, and a table which is slidably disposed in the table groove and in which a plurality of fixing holes are formed.

At least portions of an edge of the glove box door may protrude to form fixing pins, the table is movable forward or rearward inside the table groove when the glove box door opens the glove box, and the fixing pins may be inserted into the fixing holes to fix a position of the table when the glove box door closes the glove box.

The fixing pin may protrude in a direction in which the table groove is disposed and cover at least a portion of the table groove, and the fixing hole may be formed at a location corresponding to the fixing pin.

The fixing hole may include a first fixing hole formed in a front end portion of the table and a second fixing hole formed in a rear end portion of the table.

The table and an inner surface of the table groove may operate in conjunction with each other through a heart cam, and the table may be automatically pushed and withdrawn forward by an elastic force provided by an elastic member disposed at the rear end portion of the table when the table is moved a predetermined distance forward while the table is stored in the table groove.

A transfer rail may be formed inside the table groove, and the table may be moved along the transfer rail.

A width of the table and a width of the glove box door may be the same.

The glove box door may rotate about a rotary shaft formed on a lower end thereof to be opened or closed, and the table groove may be disposed in an upper side of the glove box.

The fixing pin may be formed as a pair of fixing pins on both end portions of an upper end portion of the glove box door, the first fixing hole may be formed as a pair of first fixing holes on both end portions of a front side of the table, and the second fixing hole may be formed as a pair of second fixing holes on both end portions of a rear side of the table.

A pair of third fixing holes may be formed between the first fixing holes and the second fixing holes.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a view illustrating a cockpit table assembly according to one embodiment of the present invention;

FIG. 2 is a view illustrating a table that is stored in a table groove according to one embodiment of the present invention;

FIG. 3 is a front view illustrating the table that is stored in the table groove according to one embodiment of the present invention;

FIG. 4 is a view illustrating the table according to one embodiment of the present invention;

FIG. 5 is a cross-sectional view illustrating the table that is stored in the table groove according to one embodiment of the present invention;

FIG. 6 is a cross-sectional view illustrating the table that moves forward from the table groove according to one embodiment of the present invention;

FIG. 7 is a view illustrating a process of withdrawing the table from the table groove according to one embodiment of the present invention;

FIG. 8 is a view illustrating the table and an inner side of the table groove according to one embodiment of the present invention;

FIG. 9 is a view illustrating a table according to another embodiment of the present invention; and

FIG. 10 is a view illustrating a table according to still another embodiment of the present invention.

### DETAILED DESCRIPTION OF EXEMPLARY EMBODIMENTS

Since the present invention may be variously modified and have several embodiments, specific embodiments will be illustrated in the accompanying drawings and described in detail. However, this is not intended to limit the present invention to the specific embodiments, and it should be appreciated that all changes, equivalents, and substitutes falling within the spirit and technical scope of the present invention are encompassed in the present invention. In the description of the embodiments, certain detailed descriptions of the related art will be omitted when it is deemed that they may unnecessarily obscure the gist of the inventive concept.

Terms such as “first” and “second” may be used to describe various components, but the components are not limited by the above terms. These terms are used only to distinguish one component from another.

Terms used herein are only for the purpose of describing particular embodiments and are not intended to limit the present invention. Singular forms are intended to include the plural forms, unless the context clearly indicates otherwise. In the present specification, it should be understood that the terms “comprise,” “comprising,” “include,” and/or “including” used herein specify the presence of stated features, numbers, steps, operations, elements, components, and/or combinations thereof but do not preclude the presence or addition of one or more other features, numbers, steps, operations, elements, components, and/or combinations thereof.

In addition, throughout the specification, when components are “connected,” this may not only mean that two or more components are directly connected, but this may also mean that two or more components are indirectly connected through other components or are physically connected and also electrically connected or are one component even when referred to as different names according to positions or functions thereof.

In addition, when a first component is described as being formed or disposed “on” or “under” a second component, such a description includes both a case in which the two components are formed or disposed in direct contact with each other and a case in which one or more other components are interposed between the two components. In addition, when the first component is described as being formed “on or under” the second component, such a description may include a case in which the first component is formed at an upper side or a lower side with respect to the second component.

Hereinafter, embodiments of a cockpit table assembly according to the present invention will be described in detail with reference to the accompanying drawings, and in the description with reference to the accompanying drawings, components which are the same or correspond to each other will be denoted by the same reference numerals, and redundant description thereof will be omitted.

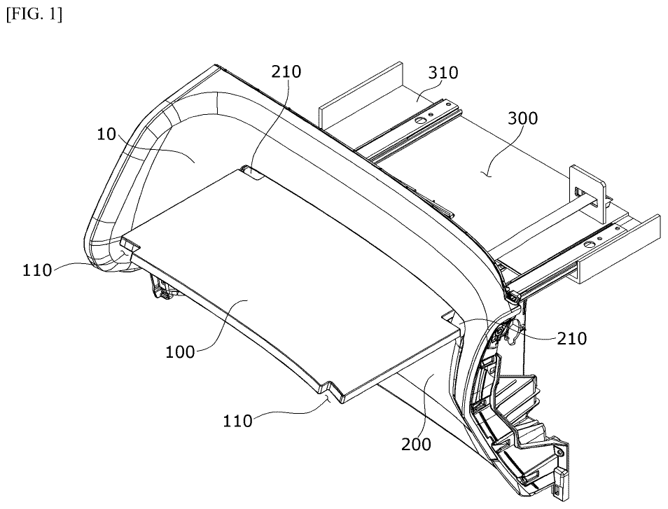

FIG. 1 is a view illustrating a cockpit table assembly according to one embodiment of the present invention;

Referring to FIG. 1, the cockpit table assembly according to one embodiment of the present invention may include a glove box door 200 which opens or closes a glove box, a table groove 300 formed in one side of the glove box, and a table 100 which may be stored in the table groove 300.

The glove box is provided in a cockpit 10 of a vehicle. The glove box may be opened or closed by the glove box door 200 and may store items therein. The table groove 300 may be formed in the at one side of the glove box. In the case of the present embodiment, it is illustrated that the table groove 300 is formed in an upper side of the glove box.

The table groove 300 may extend in a width direction of the glove box and store the table 100 therein. As illustrated in FIG. 1, the table 100 may move forward from the table groove 300 and then may be fixed. A width of the table 100 may be formed to correspond to a width of the table groove 300. The table 100 may slide inside the table groove 300 and may be moved forward or rearward.

The table 100 illustrated in FIG. 1 moves forward from the table groove 300 and is disposed to be used by a user. A fixing hole 110 may be formed in the table 100. At least a portion of an edge of the glove box door 200 may protrude to form a fixing pin 210. The fixing pin 210 may be inserted into the fixing hole 110 to fix the table 100.

In a state in which the table 100 is withdrawn forward from the table groove 300, the fixing pin 210 is inserted into the fixing hole 110 to fix a position of the table 100. In this case, the user may easily use the table 100 in the vehicle indoors.

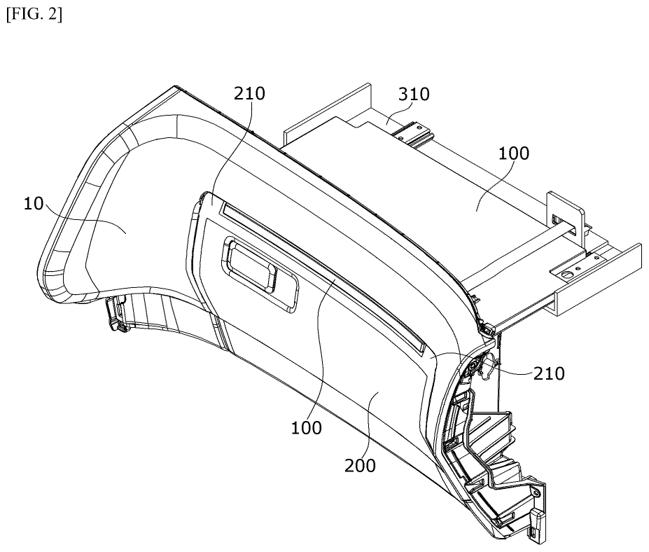

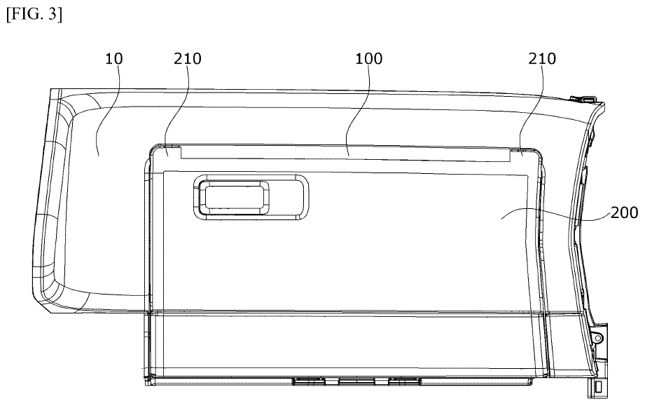

FIG. 2 is a view illustrating the table that is stored in the table groove according to one embodiment of the present invention, and FIG. 3 is a front view illustrating the table that is stored in the table groove according to one embodiment of the present invention.

When the table 100 is stored in the table groove 300, the table 100 needs to be fixedly stored. The fixing pin 210 of the glove box door 200 may be inserted into the corresponding fixing hole 110 while the table 100 is stored therein.

In the case of the present embodiment, since the table groove 300 is formed in the upper side of the glove box, the fixing pin 210 of the glove box door 200 may protrude from an upper side of the glove box door 200. The height to which the fixing pin 210 protrudes may correspond to the depth of the table groove 300.

In the state in which the table 100 is stored, when the glove box door 200 closes the glove box, the fixing pin 210 may be inserted into the fixing hole 110 and may fix the table 100 in the state in which the table 100 is stored. In the case of the present embodiment, the fixing pin 210 may cover a front side of the table 100 to prevent the table 100 from protruding. When the vehicle travels and accelerates or decelerates, since the table 100 may escape from the table groove 300 due to inertia, the fixing pin 210 may fix the table 100 by being caught in the fixing hole 110 of the table 100.

In FIG. 2, the fixing pin 210 is inserted into the fixing hole 110 formed in the front side of the table 100. When the table 100 is stored in the table groove 300, a front surface of the table 100 may be disposed to be coplanar with the cockpit 10 and the glove box door 200, thereby forming a continuous surface.

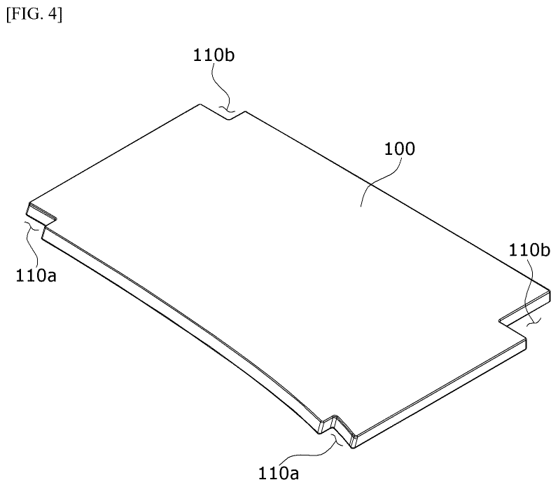

FIG. 4 is a view illustrating the table according to one embodiment of the present invention.

Referring to FIG. 4, fixing holes 110 may be formed in both end portions of the front side and a rear side of the table 100. This is similar to a shape in which at least a portion of the table 100 is bent inward. In the state in which the table 100 is stored, the fixing pin 210 is stored in the fixing hole 110 formed in the front side of the table 100. In the state in which the table 100 is withdrawn, the fixing pin 210 is stored in the fixing hole 110 formed in the rear side of the table 100.

The table 100 may include a first fixing hole 110a and a second fixing hole 110b. The first fixing hole 110a may be a pair of fixing holes 110 formed in both end portions of the front side of the table 100. The second fixing hole 110b may be a pair of fixing holes 110 formed in both end portions of the rear side of the table 100.

Based on FIG. 4, a lateral width of the fixing hole 110 may be formed to correspond to a width of the fixing pin 210. A front-rear width of the fixing hole 110 may be formed to be greater than a front-rear width of the fixing pin 210. The glove box door 200 may rotate about a hinge to open or close the glove box. The fixing pin 210 protruding from the glove box door 200 may also rotate with the glove box door 200 to be inserted into the fixing hole 110. In order to prevent the fixing pin 210 from being interfered with the table 100 when the fixing pin 210 rotates, the front-rear width of the fixing hole 110 may be formed to be greater than the front-rear width of the fixing pin 210.

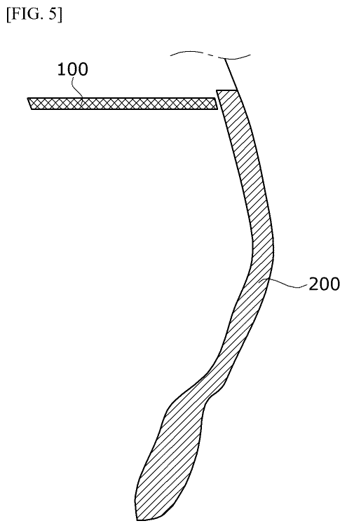

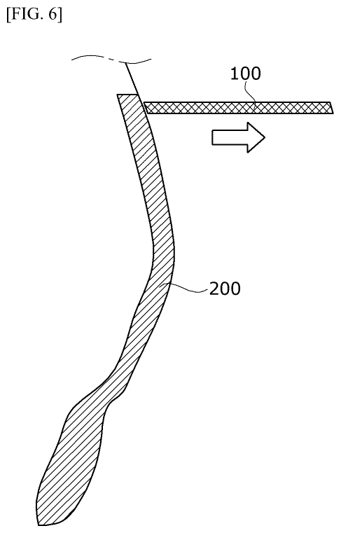

FIG. 5 is a cross-sectional view illustrating the table that is stored in the table groove according to one embodiment of the present invention, and FIG. 6 is a cross-sectional view illustrating the table that moves forward from the table groove according to one embodiment of the present invention.

The cross sections of the table 100 illustrated in FIGS. 5 and 6 correspond to cross sections of portions on which the fixing hole 110 in the front side and the fixing hole 110 in the rear side are formed.

As illustrated in FIG. 5, when the table 100 is inserted into the table groove 300, the table 100 may be fixed inside the table groove 300 by the fixing pin 210. As illustrated in FIG. 6, when the table 100 is withdrawn from the table groove 300, the table 100 may be prevented from being inserted into the table groove 300 by the fixing pin 210.

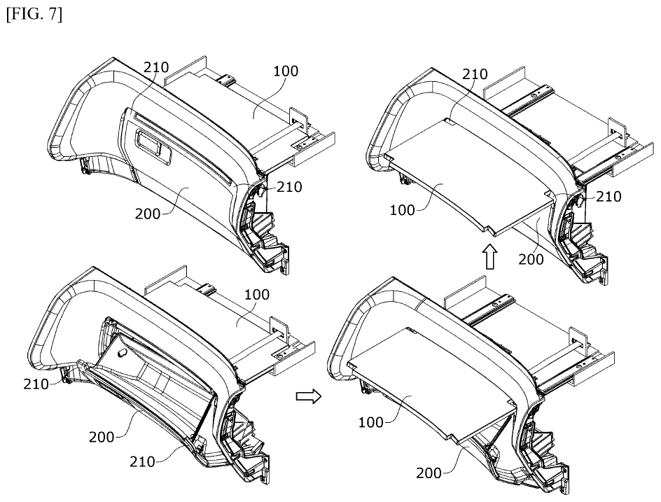

FIG. 7 is a view illustrating a process of withdrawing the table from the table groove according to one embodiment of the present invention.

Referring to FIG. 7, a process of withdrawing the table 100 stored inside the table groove 300 in the directions of arrows can be seen.

In the state in which the table 100 is stored in the table groove 300, the user may open the glove box, and the fixing pin 210 may escape from the fixing hole 110 formed in the front side of the table 100. Then, the user may withdraw the table 100 forward.

Since the table 100 may be connected to an inner wall 310 of the table groove 300 through a heart cam 400, the user may lightly push the table 100 in a direction in which the table 100 is inserted into the table groove 300 to separate the table 100 fixed using the heart cam 400. When the table 100 and the inner wall 310 of the table groove 300 are separated from the heart cam 400, the table 100 may move forward.

After the table 100 moves forward, the user may close the glove box door 200 to fix the table 100. When the glove box door 200 is closed, the fixing pin 210 may be inserted into the fixing hole 110 formed in the rear side of the table 100.

An elastic member 500 may be disposed on a rear surface of the table 100 such that the user may easily withdraw the table 100 when the table 100 is withdrawn forward from the table groove 300 in a state in which the glove box door 200 is opened. When the user lightly pushes the table 100 to separate the inner wall 310 of the table groove 300 and the table 100 which are fixed using the heart cam 400, the elastic member 500 may provide an elastic force to push the table 100 forward.

The elastic member 500 may be a leaf spring. As illustrated in the drawing, the leaf spring disposed at the rear side of the table 100 may be in a contracted state while the table 100 is stored. Then, when the fixing of the table 100 is released, an elastic force may be provided in a direction in which the table 100 is pushed forward.

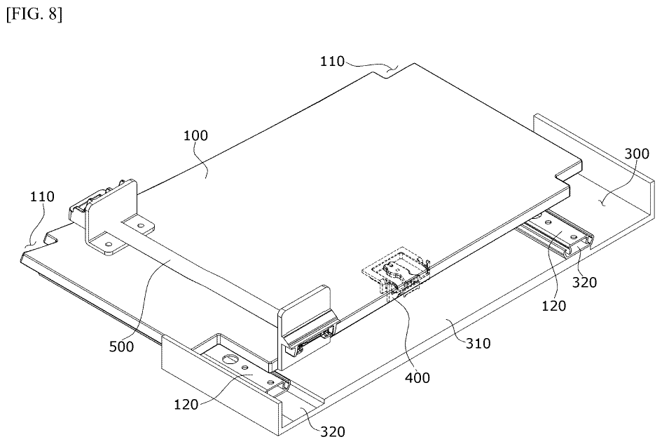

FIG. 8 is a view illustrating the table and an inner side of the table groove according to one embodiment of the present invention.

Referring to FIG. 8, the heart cam 400 connecting the table 100 and an inner surface of the table groove 300 may be disposed. The table 100 and the table groove 300 may be connected through a transfer rail 320. The transfer rail 320 may be formed inside the table groove 300, and a sliding portion 120 seated in the transfer rail 320 may be formed on a lower end of the table 100. When the table 100 moves forward or rearward, the sliding portion 120 may slide inside the transfer rail 320. The sliding portion 120 may have a fixed structure, and unlike this, a wheel may be applied to the sliding portion 120.

The elastic member 500 extending from the rear side of the table 100 to one surface of the front side of the table 100 may be disposed. The elastic member 500 may extend from the rear side to the front side of the table 100 and provide an elastic force in the direction in which the table 100 moves forward. The elastic member 500 illustrated in FIG. 8 corresponds to the leaf spring.

The table 100 and the inner wall 310 of the table groove 300 may be connected through the heart cam 400. The heart cam 400 includes a slot and a pin. The pin may move along the slot. The slot includes a section of which at least a portion is bent and catches. When the pin is disposed in the bent section of the slot, positions of the slot and the pin may be fixed. When the pin is disposed in the bent section and a predetermined force is applied, the pin is withdrawn from the corresponding section and enters a movable state. The slot may be formed in the table 100, and the pin may protrude from the inner wall 310 of the table groove 300 and may be seated in the slot. Unlike this, the pin may be formed on the table 100, and the slot may be formed in the inner wall 310 of the table groove 300.

When the table 100 is stored, the table 100 may be primarily fixed using a structure of the heart cam 400 while stored. The fixing pin 210 of the glove box door 200 may be inserted into the fixing hole 110 to secondarily stably fix the table 100.

When the user lightly pushes the table 100 stored in the table groove 300 thereinto, the pin may be withdrawn from the bent section of the slot such that the table 100 may be movably disposed. Then, when the user pushes the withdrawn table 100 into the table groove 300, the pin may be disposed in the bent section of the slot to fix the table.

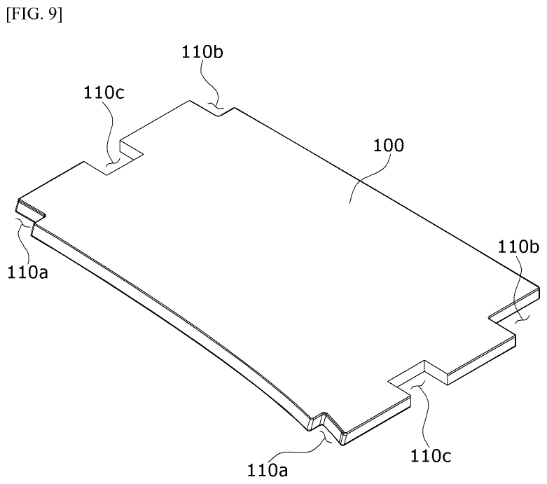

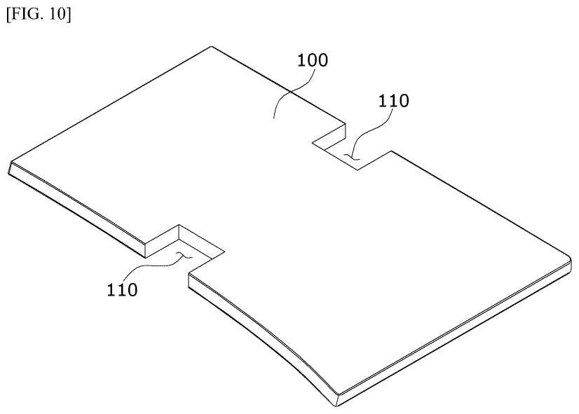

FIG. 9 is a view illustrating a table according to another embodiment of the present invention, and FIG. 10 is a view illustrating a table according to still another embodiment of the present invention.

Referring to FIG. 9, in a table 100 according to another embodiment of the present invention, another fixing hole 110 may be formed in the middle of fixing holes 110 formed in a front side and a rear side of the table 100.

A pair of fixing holes 110 formed in both end portions of the front side of the table 100 may be first fixing holes 110a. A pair of fixing holes 110 formed in both end portions of the rear side of the table 100 may be second fixing holes 110b. The table 100 according to the present embodiment may include third fixing holes 110c formed between the first fixing holes 110a and the second fixing holes 110b.

The third fixing holes 110c may be formed in the middle of the first fixing holes 110a and the second fixing holes 110b. The third fixing holes 110c may be used when only a portion of the table 100 is withdrawn from a table groove 300 and used. The user may move the table 100 forward to a portion on which the third fixing holes 110c are formed from the table groove 300. Then, the glove box door 200 may be closed such that fixing pins 210 are inserted into the third fixing holes 110c to fix the table 100.

Referring to FIG. 10, in a table 100 according to still another embodiment of the present invention, a fixing hole 110 may be formed in a central portion of the table 100.

The fixing hole 110 may be formed in a central portion of each of a front side and a rear side of the table 100. Accordingly, a fixing pin 210 of a glove box door 200 may be formed in an upper central portion of an edge of the glove box door 200. The fixing pin 210 may be inserted into the fixing hole 110 formed in the central portion to fix the table 100.

A location at which the fixing hole 110 is formed is not limited, a position of the fixing pin 210 corresponding thereto is also not limited, and any modified structure, which easily fixes the table 100, may be applied.

According to embodiments of the present invention, a table groove can be formed in one side of a glove box to store a table, and a fixing pin protruding from an edge of a glove box door can be inserted into a fixing hole of the table to fix an arrangement of the table.

Various useful advantages and effects of the present invention are not limited to the above-described contents and can be more easily understood in the detailed description of specific embodiments of the present invention.

While the present invention has been described above with reference to specific embodiments of the present invention, it may be understood by those skilled in the art that various modifications and changes of the present invention may be made within a range not departing from the spirit and scope of the present invention defined by the appended claims.

What is claimed is:

1. A cockpit table assembly comprising:
a glove box door which is pivotally coupled to a cockpit and configured to open or close a glove box;
a table groove formed in one side of the glove box in a first direction; and
a table which is slidably disposed in the table groove and in which at least one fixing hole is formed,
wherein the glove box door includes at least one fixing pin,
wherein the table is movable inside the table groove in the first direction based on that the glove box door opens the glove box, and
wherein the at least one fixing pin is inserted into the at least one fixing hole to fix a position of the table based on that the glove box door closes the glove box.

2. The cockpit table assembly of claim 1, wherein an edge of the glove box door protrudes to form the at least one fixing pin.

3. The cockpit table assembly of claim 1,
wherein the at least one fixing pin protrudes in a direction in which the table groove is disposed and covers at least a portion of the table groove, and
wherein the at least one fixing hole is formed at a location corresponding to the at least one fixing pin.

4. The cockpit table assembly of claim 2, wherein the at least one fixing hole includes a first fixing hole formed in a front end portion of the table and a second fixing hole formed in a rear end portion of the table in the first direction.

5. The cockpit table assembly of claim 4, wherein the at least one fixing hole further includes a third fixing hole formed in a middle portion of the table between the first fixing hole and the second fixing hole in the first direction.

6. The cockpit table assembly of claim 1,
wherein the table and an inner surface of the table groove operate in conjunction with each other through a heart cam.

7. The cockpit table assembly of claim 1, further including an elastic member,
wherein the table is automatically pushed and withdrawn forward by an elastic force provided by the elastic member disposed at a rear end portion of the table based on that the table is moved a predetermined distance forward in the first direction while the table is stored in the table groove.

8. The cockpit table assembly of claim 7,
wherein the elastic member includes a leaf spring disposed at a rear side of the table, and
wherein the leaf spring is in a contracted state while the table is stored in the glove box and based on that the table is released, an elastic force of the leaf spring is provided in a direction in which the table is pushed forward in the first direction.

9. The cockpit table assembly of claim 1,
wherein a transfer rail is disposed inside the table groove in the first direction, and
wherein the table is slidably movable along the transfer rail.

10. The cockpit table assembly of claim 1, wherein a width of the table and a width of the glove box door are the same.

11. The cockpit table assembly of claim 1,
wherein the glove box door is pivotal about a rotary shaft formed on a lower end thereof to be opened or closed, and
wherein the table groove is disposed in an upper side of the glove box.

12. The cockpit table assembly of claim 1,
wherein the at least one fixing pin is in pair and the pair of fixing pins is disposed on first and second end portions of an upper end portion of the glove box door in a second direction, and
wherein the at least one fixing hole is in pair on first and second end portions of the table in the second direction.

13. The cockpit table assembly of claim 1,
wherein the at least one fixing pin is in pair and the pair of fixing pins is disposed on first and second end portions of an upper end portion of the glove box door in a second direction,
wherein the at least one fixing hole is in first and second pairs,
wherein the first pair of fixing holes is formed on first and second end portions of a front side of the table in the second direction, and
wherein the second pair of fixing holes is formed on first and second end portions of a rear side of the table in the second direction.

14. The cockpit table assembly of claim 13,
wherein the at least one fixing hole further includes a third pair of fixing holes formed between the first pair of fixing holes and the second pair of fixing holes in the first direction.

15. The cockpit table assembly of claim 1, wherein a width of the at least one fixing hole in the first direction is greater than a width of the at least one fixing pin in the first direction so as to prevent the at least one fixing pin from being interfered with the table when the at least one fixing pin rotates.
